(19) United States
(12) Patent Application Publication
(10) Pub. No.: US 2016/0112359 A1
(43) Pub. Date: Apr. 21, 2016

(54) GROUP MESSAGE CONTEXTUAL DELIVERY

(71) Applicant: International Business Machines Corporation, Armonk, NY (US)

(72) Inventors: Corville O. Allen, MORRISVILLE, NC (US); James E. Carey, ROCHESTER, MN (US); Jenny S. Li, DANBURY, CT (US); John S. Mysak, ROCHESTER, MN (US)

(21) Appl. No.: 14/515,561

(22) Filed: Oct. 16, 2014

(51) Int. Cl. H04L 12/58

(52) U.S. Cl. CPC H04L 51/14

(57) ABSTRACT

A message context and delivery manager (MCDM) receives a group message designated for delivery to a plurality of recipient devices. The MCDM determines a message context of the group message, determines a sending device context of the sending device, and determines a recipient device context for each of the plurality of recipient devices. The MCDM further determines the relevance between the message context and each of the recipient device contexts and delivers the group message to the recipient devices if the message context is relevant to the recipient device contexts.

### FIELD OF THE INVENTION

Embodiments of the invention generally relate to computer systems and more particularly to delivering contextually relevant group messages based upon the context of the message, the message sender's context, and the message recipients' context.

### DESCRIPTION OF THE RELATED ART

Users of computers or other electronic devices such as mobile devices, game systems, automobile consoles, etc. receive an increasing amount of information such as, notifications, mail, calendar appointments, status feeds, sponsored advertisements, voice messages, text messages, etc., herein referred to generally as messages, from numerous services including email services, social network services, instant messaging services, short message services, voice network services, etc. Reviewing such messages efficiently is becoming difficult for such users.

Moreover, computers are increasingly present during virtually all of the user's daily activities. For example, mobile phones are increasingly used as a user's primary device to accomplish both work tasks and personal tasks. Thus, users may be presented with messages that are subject to any number of possible contexts. Accordingly, there is a need for improved techniques that enable messages be received and presented or otherwise delivered in a contextually relevant manner to the user.

### SUMMARY

In an embodiment of the present invention, a method of delivering a contextually relevant group message includes receiving, with a message context and delivery manager (MCDM) from a sending device, a group message designated for delivery to a plurality of recipient devices comprising a first recipient group and a second recipient group, determining, with the MCDM, a message context of the group message, determining, with the MCDM, a sending device context of the sending device, determining, with the MCDM, a recipient device context for each of the plurality of recipient devices, determining, with the MCDM, relevance between the message context and each of the recipient device contexts, and delivering, with the MCDM, the group message to the first recipient group if the message context is relevant to the recipient device contexts of the recipient devices within the first recipient group and the quantity of recipient devices within the first recipient group exceeds a base percentage of the plurality of recipient devices.

In another embodiment of the present invention, a method of delivering a contextually relevant group message includes receiving, with a message context and delivery manager (MCDM) from a sending device, a group message designated for delivery to a plurality of recipient devices, determining, with the MCDM, a message context of the group message, determining, with the MCDM, a sending device context of the sending device, determining, with the MCDM, a recipient device context for each of the recipient devices, determining, with the MCDM, relevance between the message context and the recipient device contexts, and delivering, with the MCDM, the group message to the plurality of recipient devices if the message context is relevant to the recipient device contexts.

In another embodiment of the present invention, a system that delivers a contextually relevant group message includes a message context and delivery manager (MCDM) that receives a group message designated for delivery to a plurality of recipient devices comprising a first recipient group and a second recipient group. The MCDM includes a message context module that determines a message context of the group message, a participant context aggregator that determines a sending device context of the sending device and determines a recipient device context for each of the plurality of recipient devices, a context relevance calculator that determines the relevance between the message context and each of the recipient device contexts, and a message agent that delivers the group message to the first recipient group if the message context is relevant to the recipient device contexts of the recipient devices within the first recipient group and the quantity of recipient devices within the first recipient group exceeds a base percentage of the plurality of recipient devices.

These and other embodiments, features, aspects, and advantages will become better understood with reference to the following description, appended claims, and accompanying drawings.

### BRIEF DESCRIPTION OF THE DRAWINGS

FIG. 1 illustrates a high-level block diagram of an exemplary computer system for implementing various embodiments of the invention.

FIG. 2 illustrates a high-level block diagram of an exemplary group message contextual delivery environment, according to various embodiments of the present invention.

FIG. 3 illustrates a high-level block diagram of an exemplary context system for determining the context of a device, according to various embodiments of the present invention.

FIG. 4 illustrates a high-level block diagram of an exemplary group message context and delivery manager 200 for determining and delivering the group message if the group message is contextually relevant, according to various embodiments of the present invention.

FIG. 5 and FIG. 6 illustrate exemplary processes for delivering contextually relevant group messages, according to various embodiments of the present invention.

FIG. 7 illustrates an exemplary process for handling contextually irrelevant group messages, according to various embodiments of the present invention.

### DETAILED DESCRIPTION

Embodiments of the invention relate to delivering contextually relevant group messages based upon the context of the message, the message sender's context, and the message recipients' context. A group message is sent from the group message sender to a plurality of recipients. The contexts' of the group message and the group message participants are utilized to designate the best time to provide the group message to the recipients. The group message may be delivered to the entire group of recipients or a sub-set of the recipients when the message is contextually relevant.

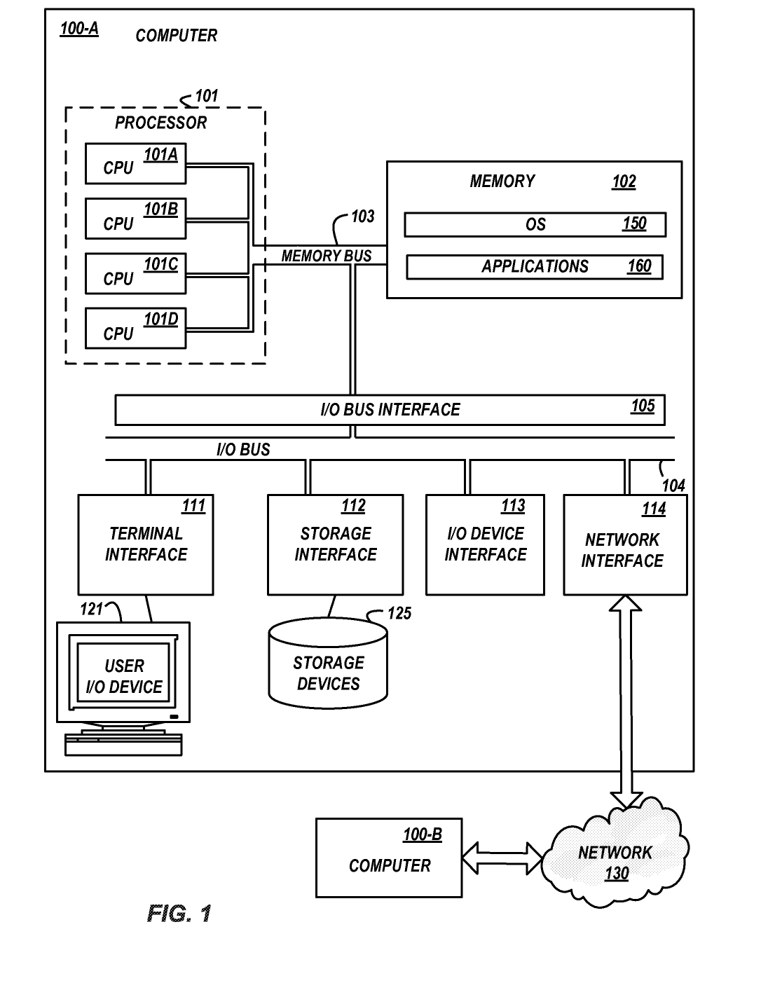

Referring to the Drawings, wherein like numbers denote like parts throughout the several views, FIG. 1 depicts a high-level block diagram representation of a computer 100-A connected to another computer 100-B via a network 130, according to an embodiment of the present invention. The term “computer” is used herein for convenience only, and in various embodiments is a more general data handling system, such as a mobile phone, tablet, server computer, etc. The mechanisms and apparatus of embodiments of the present invention apply equally to any appropriate data handling system.

The major components of the computer 100 may comprise one or more processors 101, a main memory 102, a terminal interface 111, a storage interface 112, an I/O (Input/Output) device interface 113, and a network adapter 114, all of which are communicatively coupled, directly or indirectly, for inter-component communication via a memory bus 103, an I/O bus 104, and an I/O bus interface unit 105. The computer 100 contains one or more general-purpose programmable central processing units (CPUs) 101A, 101B, 101C, and 101D, herein generically referred to as the processor 101. In an embodiment, the computer 100 contains multiple processors typical of a relatively large system; however, in another embodiment the computer 100 may alternatively be a single CPU system. Each processor 101 executes instructions stored in the main memory 102 and may comprise one or more levels of on-board cache.

In an embodiment, the main memory 102 may comprise a random-access semiconductor memory, storage device, or storage medium for storing or encoding data and programs. In another embodiment, the main memory 102 represents the entire virtual memory of the computer 100, and may also include the virtual memory of other computer systems coupled to the computer 100 or connected via the network 130. The main memory 102 is conceptually a single monolithic entity, but in other embodiments the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The main memory 102 stores or encodes an operating system 150, an application 160, and/or other program instructions. Although the operating system 150, an application 160, etc. are illustrated as being contained within the memory 102 in the computer 100, in other embodiments some or all of them may be on different computer systems and may be accessed remotely, e.g., via the network 130. The computer 100 may use virtual addressing mechanisms that allow the programs of the computer 100 to behave as if they only have access to a large, single storage entity instead of access to multiple, smaller storage entities.

Thus, while operating system 150, application 160, or other program instructions are illustrated as being contained within the main memory 102, these elements are not necessarily all completely contained in the same storage device at the same time. Further, although operating system 150, an application 160, other program instructions, etc. are illustrated as being separate entities, in other embodiments some of them, portions of some of them, or all of them may be packaged together.

In an embodiment, operating system 150, an application 160, and/or other program instructions comprise instructions or statements that execute on the processor 101 or instructions or statements that are interpreted by instructions or statements that execute on the processor 101, to carry out the functions as further described below with reference to FIGs. When such program instructions are able to be run by the processor 101, such computer 100 becomes a particular machine configured to carry out such instructions. For example, instructions for a group messaging application may be loaded upon one or more computers 100 to send a group message, determine the context of the participants of the group message, determine the context of the group message, determine the relevance of the group message to the designated recipients of the group message, and/or deliver the group message to the recipients if the group message is contextually relevant, etc.

The memory bus 103 provides a data communication path for transferring data among the processor 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The I/O interface units support communication with a variety of storage and I/O devices. For example, the terminal interface unit 111 supports the attachment of one or more user I/O devices 121, which may comprise user output devices (such as a video display device, speaker, and/or television set) and user input devices (such as a keyboard, mouse, keypad, touchpad, trackball, buttons, light pen, or other pointing device). A user may manipulate the user input devices using a user interface, in order to provide input data and commands to the user I/O device 121 and the computer 100, and may receive output data via the user output devices. For example, a user interface may be presented via the user I/O device 121, such as displayed on a display device, played via a speaker, or printed via a printer. The user interface may be a user interface that provides content to a user visually (e.g. via a screen), audibly (e.g. via a speaker), and/or via touch (e.g. vibrations, etc.). In some embodiments, the computer 100 itself acts as the user interface as the user may move the computer 100 in ways to interact with, input, or manipulate computer 100 data.

The storage interface unit 112 supports the attachment of one or more local disk drives or secondary storage devices 125. In an embodiment, the secondary storage devices 125 are rotating magnetic disk drive storage devices, but in other embodiments they are arrays of disk drives configured to appear as a single large storage device to a host computer, or any other type of storage device. The contents of the main memory 102, or any portion thereof, may be stored to and retrieved from the secondary storage devices 125, as needed. The local secondary storage devices 125 have a slower access time than does the memory 102, meaning that the time needed to read and/or write data from/to the memory 102 is less than the time needed to read and/or write data from/to for the local secondary storage devices 125.

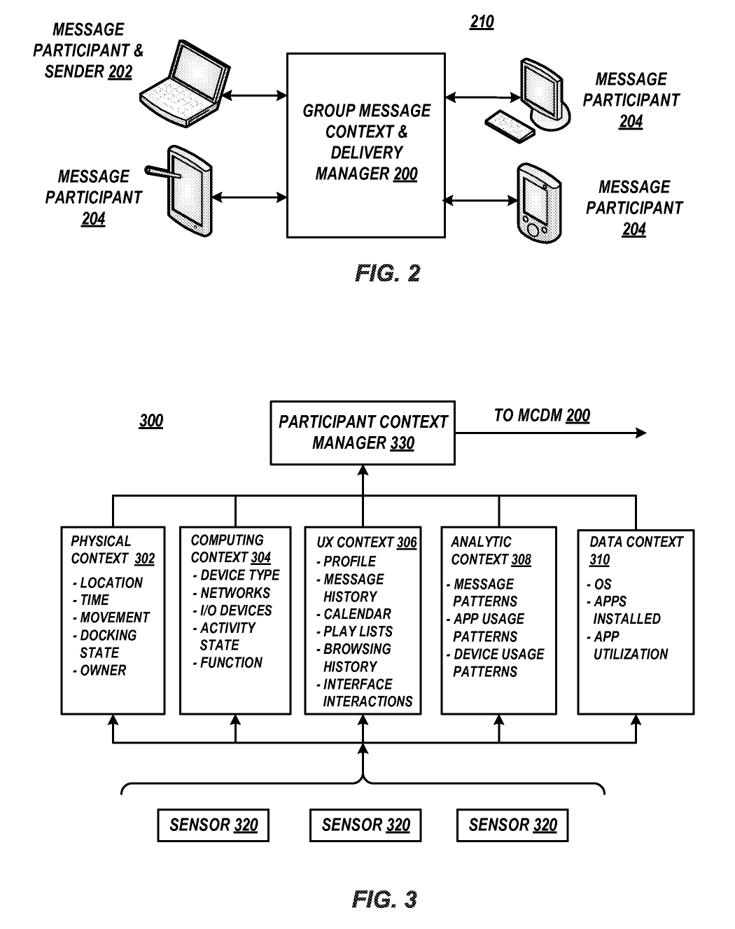

The I/O device interface 113 provides an interface to any of various other input/output devices or devices of other types, such as printers or fax machines. The network adapter 114 provides one or more communications paths from the computer 100 to other data handling devices such as numerous other computers; such paths may comprise, e.g., one or more networks 130. Although the memory bus 103 is shown in FIG. 2 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 105 and the I/O bus 104 are shown as single respective units, the computer 100 may, in fact, contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

I/O interface 113 may contain electronic components and logic to adapt or convert data of one protocol on I/O bus 104 to another protocol on another bus. Therefore, I/O interface 113 may connect a wide variety of devices to computer 100 and to each other such as, but not limited to, tape drives, optical drives, printers, disk controllers, other bus adapters, PCI adapters, workstations using one or more protocols including, but not limited to, Token Ring, Gigabyte Ethernet, Ethernet, Fibre Channel, SSA, Fiber Channel Arbitrated Loop (FCAL), Serial SCSI, Ultra3 SCSI, Infiniband, FDDI, ATM, 1394, ESCON, wireless relays, Twinax, LAN connections, WAN connections, high performance graphics, etc.

Though shown as distinct entities, the multiple I/O interface units 111, 112, 113, and 114 or the functionality of the I/O interface units 111, 112, 113, and 114 may be integrated into a similar device.

In various embodiments, the computer 100 is a multi-user mainframe computer system, a single-user system, a server computer or similar device that has little or no direct user interface, but receives requests from other computer systems (clients). In other embodiments, the computer 100 is implemented as a desktop computer, portable computer, laptop or notebook computer, tablet computer, pocket computer, telephone, smart phone, pager, automobile, teleconferencing system, appliance, or any other appropriate type of electronic device.

The network 130 may be any suitable network or combination of networks and may support any appropriate protocol suitable for communication of data and/or code to/from the computer 100-A and at least the computer 100-B. In various embodiments, the network 130 may represent a data handling device or a combination of data handling devices, either connected directly or indirectly to the computer 100. In another embodiment, the network 130 may support wireless communications. In another embodiment, the network 130 may support hard-wired communications, such as a telephone line or cable. In another embodiment, the network 130 may be the Internet and may support IP (Internet Protocol). In another embodiment, the network 130 is implemented as a local area network (LAN) or a wide area network (WAN). In another embodiment, the network 130 is implemented as a hotspot service provider network. In another embodiment, the network 130 is implemented an intranet. In another embodiment, the network 130 is implemented as any appropriate cellular data network, cell-based radio network technology, or wireless network. In another embodiment, the network 130 is implemented as any suitable network or combination of networks. Although one network 130 is shown, in other embodiments any number of networks (of the same or different types) may be present.

FIG. 1 is intended to depict the representative major components of the computer 100. But, individual components may have greater complexity than represented in FIG. 1, components other than or in addition to those shown in FIG. 1 may be present, and the number, type, and configuration of such components may vary. Several particular examples of such additional complexity or additional variations are disclosed herein; these are by way of example only and are not necessarily the only such variations. The various program instructions implementing e.g. upon computer system 100 according to various embodiments of the invention may be implemented in a number of manners, including using various computer applications, routines, components, programs, objects, modules, data structures, etc., and are referred to hereinafter as “computer programs, “or simply “programs.”

The present invention may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate exemplary architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

FIG. 2 illustrates a high-level block diagram of an exemplary group message contextual delivery environment 210, according to various embodiments of the present invention. Environment 210 includes numerous group message participants and a group message context and delivery manager (MCDM) 200. The group message participants include the group message sender 202 and numerous group message recipients 204. The participants and/or MCDM 200 may be embodied by e.g. respective computers 100. For example, the sender 202 may be a mobile phone, the MCDM 200 may be a messaging service server, and the recipients 204 may be other computers 100. Alternatively, MCDM 200 may be a component within a particular participant. For example, MCDM 200 may be electronic circuitry, programmable logic circuitry, FPGA, PLA, processor 101, etc. that implements associated program instructions corresponding to applicably functionality as described herein, etc. MCDM 200 generally determines the context of each of the participants, determines the context of the group message, determines the relevance of the group message to each of the designated recipients 204 and delivers the group message to the recipients 204 when the group message is contextually relevant. In certain embodiments, such as those where MCDM 200 is a distinct device relative to the participants, the MCDM 200 may also receive the group message from the sender 200.

In various embodiments the MCDM 200 determines when the group message is contextually relevant. For example, in certain embodiments, the MCDM 200 may delay the delivery of the group message until all recipients 204 of the message are available, active, etc. In determining whether the group message is contextually relevant, the MCDM 200 may utilize a global requirement that must be satisfied by each and every recipient 204 for the group message to be contextually relevant. For example, the MCDM 200 may require that a group message that is determined to be a “work” message be delivered to the recipients 204 when it is determined that all of the recipients 204 are in an “work” context. Further, the MCDM 200 may utilize partial requirements that must be satisfied by a sub-group of a plurality of recipients 204 amongst all of the recipients 204 for the group message to be contextually relevant to the sub-group. For example, the MCDM 200 may require that the determined “work” group message be delivered to a sub-group of the recipients 204 when the percentage of the sub-group in a “work” context exceeds a percentage of the total number of recipients 204.

In various embodiments, the MCDM 200 may determine whether the group message is contextually relevant to the recipients 204 by calculating a relevance score and determining whether the relevance score is above a relevance threshold. In some embodiments, the relevance score may be determined by the MCDM 200 comparing a physical context, a computing context, a user context, an analytic context, and/or a data context of each participant with the context of the group message. In other embodiments, the relevance score may be determined by the MCDM 200 receiving participant contexts from each respective participant and comparing the received contexts with the context of the group message. In embodiments, the relevance score increases as the similarities between the contexts of the group message and group message participants increase. For example, the calculated relevance score of a work message sent by a technical employee to technical colleges that are members of a project may be higher than the calculated score of a work message sent to colleges of a different organizational division.

In some embodiments, if the calculated relevance score is below the relevance threshold, the MCDM 200 may estimate when the group message will become contextually relevant to the recipients 204 and may provide the estimate to the group message sender 202. In some embodiments, the MCDM 200 may further provide to the message sender 202 associated estimation reasoning why MCDM 200 estimates that the group message will become contextually relevant to the recipients 204. For example, the MCDM 200 may determine that a work message is not presently contextually relevant to recipients 204 but will become contextually relevant at the commencement of the workday. The MCDM 200 may prompt the sender 202 that the group message is expected to be contextually relevant at e.g. 8:00 am when a percentage of the recipients 204 are expected to have logged into, or otherwise have activated, respective work devices. In some embodiments, the MCDM 200 may further prompt the group message sender 202 of delivery resolutions that may increase the contextual relevance such that the group message may be delivered.

In some embodiments, the MCDM 200 may prompt the sender 202 that is drafting a group message of pending or imminent expected changes to respective contexts of recipients 204. For instance, MCDM 200 may prompt the sender 202 that it expects that a sub-group of recipients 204 is likely to become inactive within the next hour and will not likely become active for the next twelve hours. Such prompt may result in the sender 202 to send the group message to MCDM 200 to deliver the contextually relevant message to the recipients 204. In other embodiments, the MCDM 200 may prompt the group message sender 202 to indicate or confirm the status of each recipient. For example, the MCDM 200 may prompt the sender 202 to indicate whether each recipient 204 is required, optional, etc.

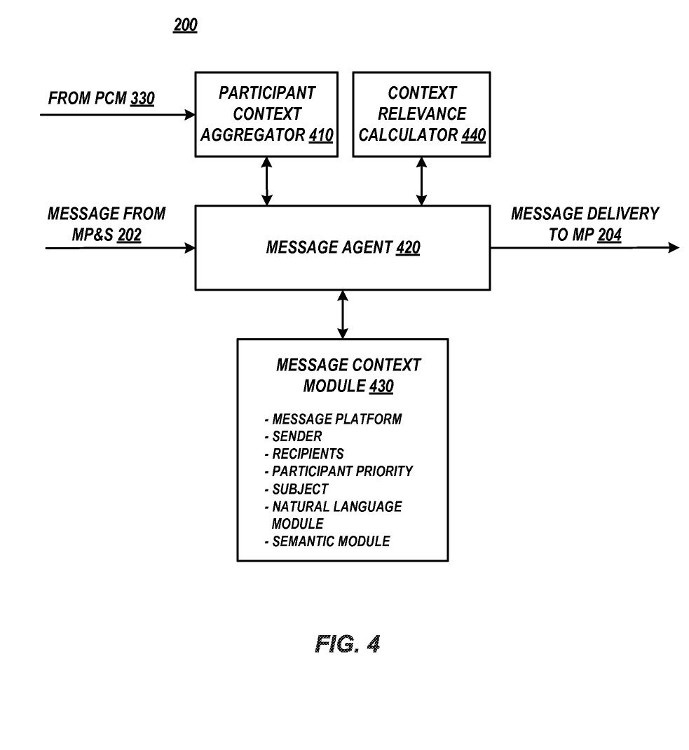

FIG. 3 illustrates a high-level block diagram of an exemplary context system 300 for determining the context of a participant device, according to various embodiments of the present invention. Context system 300 may include a physical context module 302, a computing context module 304, a user context module 306, an analytic context module 308, a data context module 310, one or more sensors 320 local to participant devices, and/or a participant context manager 330. In certain embodiments, MCDM 200 may determine the context of the participant device directly from one or more of the physical context module 302, a computing context module 304, a user context module 306, an analytic context module 308, and/or data context module 310. For example, the MCDM 200 and manager 330 may be integrated into a similar module within a participant device. In other embodiments, participant context manager 330 may determine the context of the participant device from one or more of the physical context module 302, a computing context module 304, a user context module 306, an analytic context module 308, and/or data context module 310. The MCDM 200 may then determine the participant context via communicating with manager 330. For example, manager 300 may be integral to a participant device and communicates with MCDM 200 integral to a messaging service server via network 130.

Physical context module 302, computing context module 304, user context module 306, analytic context module 308, data context module 310, manager 330 may be electronic circuitry, programmable logic circuitry, FPGA, PLA, processor 101, etc. that implements associated program instructions corresponding to applicably functionality as described herein, etc. In certain embodiments, physical context module 302, computing context module 304, user context module 306, analytic context module 308, and/or data context module 310 may be local to a participant device. In other embodiments, physical context module 302, computing context module 304, user context module 306, analytic context module 308, and/or data context module 310 may be peripheral to the participating device. For example, physical context module 302, computing context module 304, user context module 306, analytic context module 308, and/or data context module 310 may be local to MCDM 200 integrated into a messaging service server.

Generally, sensor 320 is an output element that communicates data to one or more of the physical context module 302, computing context module 304, user context module 306, analytic context module 308, and/or data context module 310 so that the respective modules may determine applicable contexts. Sensor 320 may take a variety of forms and may be a physical device (e.g. global positioning device, accelerometer, light sensor, compass, gyroscope, touch pad, temperature sensor, microphone, camera, network interface, docking sensor, etc.), program instructions evoked by e.g. processor 101 (e.g. tracking software, clock, etc.), or data pre-loaded into memory 102 of participating devices (e.g. MAC address, device type model, etc.). Sensor 320 may generate or otherwise provide dynamic output data (e.g. most recent application 160 utilizations, location of the participating device, current owner of the participating device, etc.) or may provide static output data (e.g. participating device type data, etc.). In certain embodiments, one or more sensors 320 may be local to a participant device. In other embodiments, one or more sensors 320 may be peripheral to the participating device. For example, a sensor 320 may be local to a messaging service server.

In an exemplary embodiment, the manager 330 characterizes the user's context based on information received from one or more the physical context module 302, computing context module 304, user context module 306, analytic context module 308, and/or data context module 310. Information pertaining to the participant device context is captured and passed to manager 330 for analysis. The manager 330 may creates, maintains, and/or updates one or more models pertaining to the participating device context that integrate multiple areas of a computerized environment, such as physical, mental, computing, analytic, and data. In the illustrated exemplary implementation, the participating device context module 302 gathers information on the participating device physical environment, the participating device computing context, the participating device user context, the participating device predictive or analytic context, and the participating device data context.

The physical context module 302 generates information pertaining to the participating device present location (e.g., geographical, relative to a structure such as a building, etc.), the current time (e.g. the local time and time zone, etc.), the velocity or acceleration, the docking state (e.g. whether the participating device is docked to a vehicle, etc.), and the owner of the device. Other possible information related to the physical environments include nearby devices (e.g. detectable via, e.g. Bluetooth, etc.), the participating device user's body state, or other environmental factors that can be externally sensed by the participating device. As an example, the physical context module 302 may determine the absence of light via a light sensor 320 and determine a night time via a clock sensor 320 and resulting determine that the participating device user is asleep. In another example, the physical context module 302 may determine that the participating device is located in e.g., the Central Time Zone and/or e.g., Rochester, Minn. The physical context module 302 may also determine that the participating device is owned by a corporate entity that is provided to an employee to accomplish work tasks.

The computing context module 304 generates information pertaining to the computing capabilities of the participating device, including the participating device type (e.g. the participating device is a mobile phone, notebook computer, etc.), available I/O devices (e.g., keyboards, buttons, microphones, cursor controllers, connectivity (e.g., amount of bandwidth, security level, cost, strength, protocol, quality, media type, schedule, etc.), activity state, processing capabilities, available storage space, and anything else that the local and remote computing context environment can self-characterize. As an example, the computing context module 304 may determine the participating device is connected to a corporate entity intranet, a private network, a virtual private network, etc. Further, the computing context module 304 may determine the activity level of the participating device has been dormant or otherwise inactive (e.g. the participating device is powered on but not in use, etc.). Further, the computing context module 304 may determine how the participating device is functioning, e.g., the mobile phone is being utilized to compose an instant message, text message, make a phone call, browse the internet, etc.

The user context module 306 generates information pertaining to the user of the participating device including user profiles, the history of messages sent or received, calendar information, play lists, browsing history, and history of interactions with various interfaces (e.g. GUIs, etc.) provided by the participating device. As an example, the user context module 306 tracks internet browsing history, tracks mouse clicks of a GUI of a particular application 160, identifies content of one or more user profiles, etc. Further, the user context module 306 may use data from a pupil tracking sensor or head orientation sensor to identify a direction or object the user of the participating device is focused. Further, the user context module 306 may generate user preference metrics from user profiles to differentiate or indicate that family is highly important while advertisements are the lowest level of importance.

The analytic context module 308 generates information pertaining to patterns of the participating device including message patterns, application 160 usage patterns, and participating device usage patterns. For example, the analytic context module 308 may determine a pattern that the participating device generally becomes active for an average of five minutes at night when a message application 160 (e.g. email, etc.) is utilized. Analytic context module may also determine a pattern of a work related instant messaging application 160 becoming inactive between 12:00 pm and 1:00 pm during the weekday. In embodiments, the analytic context module 308 generates information pertaining to the participating device future functionality based upon the determined pattern.

The data context module 310 generates information pertaining to the data and software resources on the participating device, including the communication resources, applications, operating system, and data. As an example, the data context module 310 may determine what applications 160 and what operating systems 150 are installed. Further the data context module 310 may determine the utilizations of the various applications 160. For instance, the data context module 310 may determine that a particular application 160 is extensively utilized Monday through Friday between the hours of 9:00 am and 5:00 pm. The data context module 310 may also determine the owner, licensee, provider, or source of the applications 160. For instance, the data context module 310 may determine that the most extensively utilized applications 160 during a particular time period were not installed by the participating device owner.

Generally, one or more of the denoted functions of physical context module 302, computing context module 304, user context module 306, analytic context module 308, or data context module 310 may be included or carried out by another module. Further, the physical context module 302, computing context module 304, user context module 306, analytic context module 308, and/or data context module 310 may be in relative communication. For example, the analytic context module 308 may query or generally receive information determined or gathered by one or more of the physical context module 302, computing context module 304, user context module 306, and/or data context module 310 to generate pattern information.

The participant context manager 330 takes the information generated by the environment modules 314-320 and generates a cohesive determination of the participant device context based on one or more context models. The model(s) can be broad, dynamic, explicit, and capable of being understood by arbitrary software modules. The determine participant device context may be provided to the manager 330. Alternatively, the manager 300 may directly determine the cohesive the participant device context based on the one or more context models. The context models may utilize one or more filters to the information provided by the various physical context module 302, computing context module 304, user context module 306, analytic context module 308, and/or data context module 310 to determine the participant device context. The filters may be dynamic and can be changed as the participant device conditions change. New filters may be added or created, while others are dropped as the participant device context evolves. A particular filter may weight information from a particular physical context module 302, computing context module 304, user context module 306, analytic context module 308, and/or data context module 310 higher than other modules. For example, if particular data from a particular module is highly correlated with the current actual context of the participating device, the filer may weight such data high to accurately determine the context.

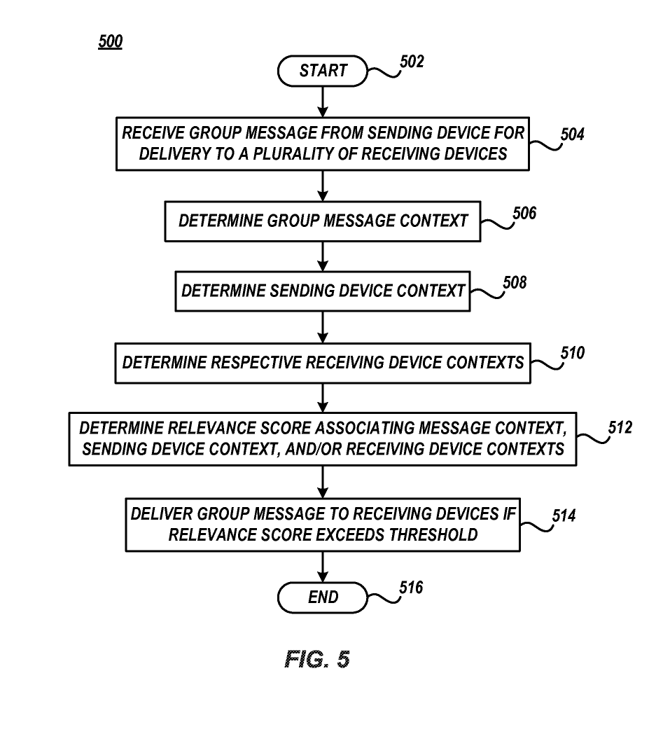

FIG. 4 illustrates a high-level block diagram of an exemplary MCDM 200 for determining and delivering the group message if the group message is contextually relevant, according to various embodiments of the present invention. In an exemplary embodiment, MCDM 200 may include a participant context manager 410, a message agent 420, a message context module 430, and/or a context relevance calculator 440.

The illustrated embodiment of MCDM 200 includes message agent 420 that receives the group message from sender 202, determines the context of the message via message context module 430, determines contexts of respective participant devices via participant context aggregator 410, and delivers the group message to the recipients 204 when the context relevance score, determined via context relevance calculator 440, exceeds a relevance threshold. For example, the agent 420 may receive a group message, store the group message in a message queue, and delay delivery of the message to recipients only when the message is contextually relevant to the recipients 204. In certain embodiments, if the delivery is delayed over a threshold period of time, the group message may be deleted from the message queue. In this instance, the agent 420 may send a notification to the group message sender 402 that the delivery of the group message failed.

The participant context aggregator 410 may provide the determined context of each of the participant devices associated with a received group message to message agent 420. In various embodiments the participating device contexts may be dynamically received by aggregator 410 via the aggregator 410 querying appropriate participant context managers 330. In certain embodiments, the agent 420 may receive the group message from sender 202, may determine additional participants (e.g. the recipients 204, etc.), and may query the participant context manager 410 to receive the determined contexts for each participating device. For example, a group message from sender 202 to recipients 204A, 204B, and 204C is received by agent 420 which, in turn, queries aggregator 410 to provide the contexts for sender 202 and each recipient 204A, 204B, and 204C. Aggregator 410, in turn, queries respective managers 330 of sender 202 and each recipient 204A, 204B, and 204C, receives the determined context of each participating device, and returns the contexts of sender 202 and each recipient 204A, 204B, and 204C to agent 420.

The message context module 430 generates information pertaining to the context of the sent group message, including information associated with the platform on which the group message is composed, information associated with the sender 202 and recipients 204 (e.g. whether an email address of the sender 202 and/or recipient 204 is associated with work, personal, etc.), information associated with the priority or importance of the sender 202 and/or recipient 204, information related to the subject, time of day sent, body (e.g. length, message complexity, text, pictures, language, etc.). In embodiments the message context module 430 may include analytic modules such as a natural language module, a semantic module, a ontology module that may be utilized to determine language patterns, link phrases, or otherwise analyze the content of the group message to determine the context thereof. For example, the analytic modules may analyze a group message including the terms: “waiver wire,” “injury,” “points,”, “yards,” “receptions,” and determine various the following contexts: “personal,” “fantasy football,” “NFL®, “friends,” “league,” etc.

The context relevance calculator 440 compares the determined context of respective message participants and the determined context of the group message. In embodiments, the relevance calculator 440 determines a relevance score indicative of the similarities or level of correlation between the determined context of respective message participants and the determined context of the group message. For instance, if the sender 202 and recipients 204 have a “work” context and the group message also has a “work” context, a relevance score component associating these contexts would indicate a high level of similarity. Further, a sender 202 having a “buyer” context may send a group message having an “open house,” “Realtor®,” and “square foot” context to numerous recipients 204. A high relevance score associating those contexts with recipients 204 having a “mortgage broker” context may indicate a high level of correlation while a lower relevance score associating those contexts with recipients 204 having a “contractor” context may indicate a lower level of correlation, while an even lower relevance score associating those contexts with recipients 204 having a “bakery” context may indicate an even lower level of correlation. Context relevance calculator 440 may utilize an adjustable relevance threshold. The relevance threshold may be set by e.g. participating devices. For example, the relevance threshold may be set by one of the recipients 204. In certain embodiments, the relevance threshold may be set by a particular recipient 204 amongst the plurality of recipients 204 that indicates the strictest relevant score (i.e. the recipient 204 that wishes to receive only the most relevant group messages to its present context). In other embodiments, the relevance threshold may be set by an administrator such as a messaging service server administrator.

In various embodiments, the agent 420 delivers the received group message if the context of the group message is contextually relevant to the recipients. In certain embodiments, the group message is contextually relevant to the recipients if the context of the sender 202 and the context of the message are similar to the context of the recipients 204. In certain embodiments, the group message is contextually relevant to the recipients if the context of the sender 202 and the context of the message are correlated to the context of the recipients 204. In implementations, the agent 420 delivers the received message to the recipients 204 if the relevance score exceeds the relevance threshold.

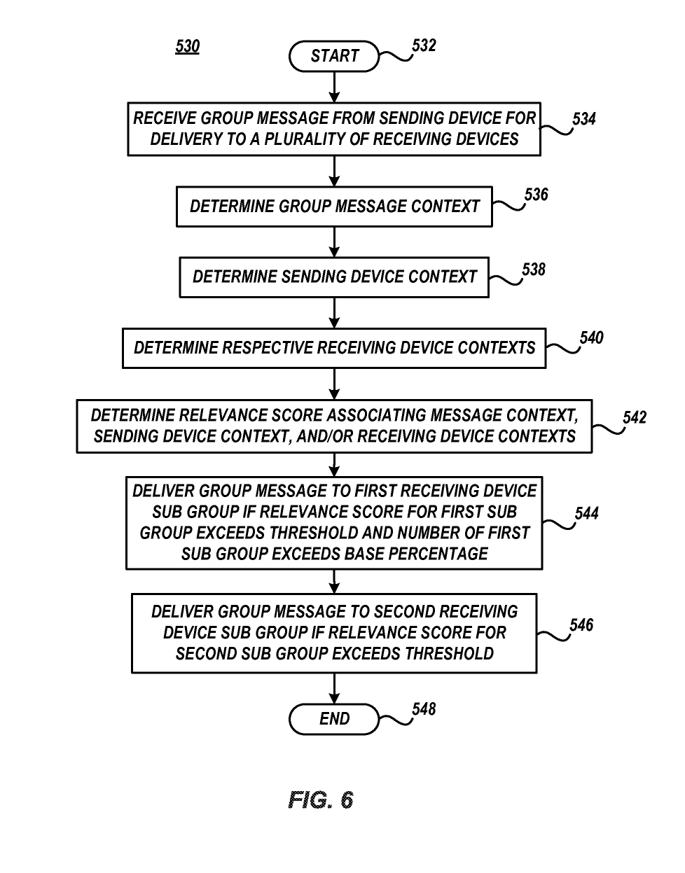

FIG. 5 illustrates exemplary method 500 for delivering contextually relevant group messages, according to various embodiments of the present invention. Method 500 may be utilized by e.g., processor 101, MCDM 200, etc. to provide a contextually relevant group message to recipients 204. Process 500 begins at block 502 and continues with receiving a group message from a sending device that is to be delivered to two or more receiving devices (block 504). For example, agent 420 receives a group message from sender device 202 to be delivered to recipient devices 204 and locally stores the group message (e.g. in memory 102, storage device 125, etc.) in a group message queue.

Method 500 may continue with determining the context of the group message (block 506). For example, message context module 430 determines the context of the group message by considering e.g., the group message platform, the identity or context of the sender 202, the identity or context of the recipients 204, the priority or importance of the recipients 204, the subject of the group message, the body content of the group message, a natural language analysis of the group message, a semantic analysis of the group message, an ontological analysis of the group message, etc. As another example, the agent 420 may determine the context of the group message by querying the message context module 430 and the message context module 430 returning the context of the group message to the agent 420.

Method 500 may continue with determining the context of the sending device (block 508). For example, message agent 420 may query the participant context manager 330 of the sender 202 and the manager 330 returning the sender 202 context to MCDM 200. As another example, the participant context manager 330 of the sender 202 may determine the context of the sender 202 by applying a filter to information provided by associated physical context module 302, computing context module 304, user context module 306, analytic context module 308, and/or data context module 310. Manager 330 may weight such filtered information more than other filtered information to best determine the sender device 202 context.

Method 500 may continue with determining respective contexts of the recipient devices (block 510). For example, participant context aggregator 410 may determine the identity of each group message participant amongst a plurality of possible recipients. The aggregator 410 may query the participant context manager 330 of those applicable group message recipients wherein respective managers' 330 return the recipient 204 context to MDCM 200. As another example, the participant context manager 330 of each recipient 204 may determine the context of the device by applying a filter to information provided by associated physical context module 302, computing context module 304, user context module 306, analytic context module 308, and/or data context module 310. Manager 330 may weight such filtered information more than other filtered information to best determine the recipient device 204 context.

Method 500 may continue with determining a relevance score associating at least the message context and the receiving device contexts (block 512). In certain implementations, the relevance score may be determined that associates the message context the receiving device contexts and the context of the sending device. For example, context relevance calculator 440 may determine the relevance score based upon the similarity of the applicable contexts, the correlation between the applicable contexts, or a combination of the similarly and the correlation between the applicable contexts.

Method 500 may continue with delivering the group message to the receiving devices if the relevance score exceeds a relevance threshold (block 514). For example, agent 420 obtains the group message from the message queue and delivers the group message to those recipients 204 associated with a relevance score that exceeds the relevance threshold. In a particular example, the group message from sender 202 to recipients 204A, 204B, and 204C is delivered to recipients 204A and 204B since the relevance score associating the context of recipients 204A and 204B and the context of the group message exceeds the set relevance score and the group message from sender 202 is not delivered to recipient 204C since the relevance score associating the context of recipient 204C and the context of the group message does not exceed the set relevance score. In this manner, the group message may be delivered to recipients when the group message is contextually relevant thereto. Method 500 ends at block 516.

FIG. 6 illustrates exemplary process 530 for delivering contextually relevant group messages, according to various embodiments of the present invention. Method 530 may be utilized by e.g., processor 101, MCDM 200, etc. to provide a contextually relevant group message to a first sub group of recipients 204 and subsequently to a second sub group of recipients 204. Process 530 begins at block 532 and continues with receiving a group message from a sending device that is to be delivered to a plurality of receiving devices comprising a first sub group and a second sub group (block 534). For example, agent 420 receives a group message from sender device 202 to be delivered to recipient devices 204 and locally stores the group message (e.g. in memory 102, storage device 125, etc.) in a group message queue.

Method 530 may continue with determining the context of the group message (block 536). For example, message context module 430 determines the context of the group message by considering e.g., the group message platform, the identity or context of the sender 202, the identity or context of the recipients 204, the priority or importance of the first group and/or second group of recipients 204, the subject of the group message, the body content of the group message, a natural language analysis of the group message, a semantic analysis of the group message, an ontological analysis of the group message, etc. As another example, the agent 420 may determine the context of the group message by querying the message context module 430 and the message context module 430 returning the context of the group message to the agent 420.

Method 530 may continue with determining the context of the sending device (block 538). For example, message agent 420 may query the participant context manager 330 of the sender 202 and the manager 330 returning the sender 202 context to MCDM 200. As another example, the participant context manager 330 of the sender 202 may determine the context of the sender 202 by applying a filter to information provided by associated physical context module 302, computing context module 304, user context module 306, analytic context module 308, and/or data context module 310. Manager 330 may weight such filtered information more than other filtered information to best determine the sender device 202 context.

Method 530 may continue with determining respective contexts of the recipient devices (block 540). For example, participant context aggregator 410 may determine the identity of each receiver of the first group and second group amongst a plurality of possible recipients 204. The aggregator 410 may query the participant context manager 330 of those applicable group message recipients 204 wherein respective managers' 330 return the first group and second group of recipient 204 contexts to MDCM 200. As another example, the participant context manager 330 of each of the first group and second group of recipients 204 may determine the context of the respective device by applying a filter to information provided by associated physical context module 302, computing context module 304, user context module 306, analytic context module 308, and/or data context module 310. Manager 330 may weight such filtered information more than other filtered information to best determine the first group and second group of recipient device 204 contexts.

Method 530 may continue with determining a relevance score associating at least the message context and the first group and second group of receiving device contexts (block 542). In certain implementations, the relevance score may be determined that associates the message context the first group and second group of receiving device contexts and the context of the sending device. For example, context relevance calculator 440 may determine the relevance score based upon the similarity of the applicable contexts, the correlation between the applicable contexts, or a combination of the similarly and the correlation between the applicable contexts.

Method 530 may continue with delivering the group message to the first group of receiving devices if the relevance score exceeds a relevance threshold for each recipient in the first group of recipients and if the number of the first group of receiving devices exceeds a base percentage of the total number of recipients of the group message (block 544). For example, agent 420 obtains the group message from the message queue and delivers the group message to the first group recipients 204 associated with a relevance score that exceeds the relevance threshold when the number of the first group exceeds a base percentage. For instance, if the relevance score exceeds the relevance threshold and the number of the first group of recipients 204 is a majority of the total number of recipients 204, the group message is sent to the first group of recipients 204. As another example, the group message is not sent to the first group of recipients 204 if the number of the first group of recipients 204 is not greater than eighty percent of the total number of recipients.

Method 530 may continue by delivering the group message to the second group of recipients if the calculated relevance score exceeds a relevance threshold for each of the recipients in the second group of recipients (block 546). Method 530 ends at block 548.

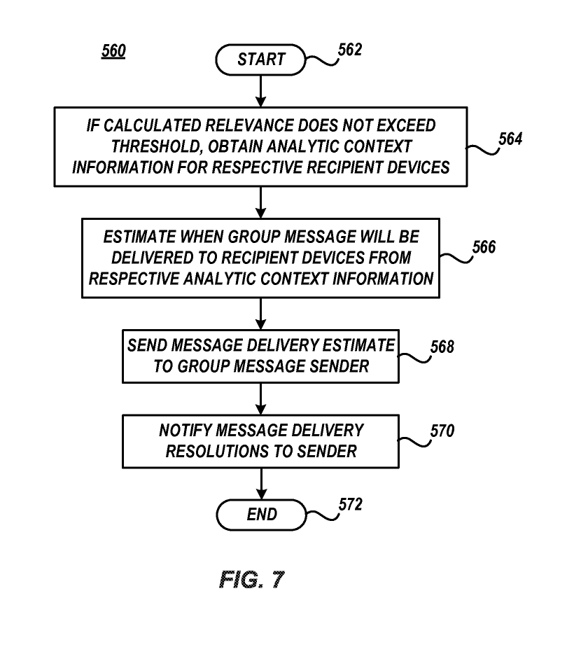

FIG. 7 illustrates an exemplary method 560 for handling contextually irrelevant group messages, according to various embodiments of the present invention. Method 560 may be utilized by e.g., processor 101, MCDM 200, etc. to handle a contextually irrelevant group message. Process 560 begins at block 562 and continues by obtaining analytic or otherwise predictive context information associated with those recipient devices for which the group message has been determine irrelevant (block 564). For example, MCDM 200 may obtain predictive or analytic context information from analytic context module 308. In another example, participant context aggregator 410 may query participant context manager 330 that, in turn, may query analytic context module 308 to determine predicted context changes. The manager 330 may return the context change information to aggregator 410 that, in turn, may return the context change information to agent 420.

Method 560 may continue by estimating when the group message will be delivered to the recipient devices (block 566) and providing the estimate to the group message sender (block 568). For example, MCDM 200 may utilize the context change information provided by analytic context module 308 to notify the sender 202 of when the group message is predicted to be delivered. Method 560 may continue by notifying the message sender of possible resolutions for the message to become contextually relevant to the recipients (block 570). For example, MCDM 200 may indicate to the sender 202 that the group message will become contextually relevant to a recipient 204 if the priority of the group message is increased. Method 560 ends at block 572.

Unless otherwise indicated herein, participant device context are the present condition, circumstance, etc. associated with the participant device or user of the participant device that exist where and when the group message is sent and that helps explain the actions, activity, state of mind, etc. of the participant device user. Further, unless otherwise indicated herein, message context is the condition associated with the group message that helps explain the group message meaning. Numerous contexts may be applicable to each group message and to each group message participant.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over those found in the marketplace, or to enable others of ordinary skill in the art to understand the embodiments disclosed herein.

What is claimed is:

1. A method of delivering a contextually relevant group message comprising:
receiving, with a message context and delivery manager (MCDM) from a sending device, a group message designated for delivery to a plurality of recipient devices comprising a first recipient group and a second recipient group;
determining, with the MCDM, a message context of the group message;
determining, with the MCDM, a sending device context of the sending device;
determining, with the MCDM, a recipient device context for each of the plurality of recipient devices;
determining, with the MCDM, relevance between the message context and each of the recipient device contexts, and;
delivering, with the MCDM, the group message to the first recipient group if the message context is relevant to the recipient device contexts of the recipient devices within the first recipient group and the quantity of recipient devices within the first recipient group exceeds a base percentage of the plurality of recipient devices.

2. The method of claim 1 further comprising:
determining the relevance between the message context, the recipient device contexts, and the sending device context.

3. The method of claim 1, wherein determining the relevance between the message context and the recipient device contexts further comprises:
calculating a relevance score measuring the similarity of the message context with the recipient device contexts.

4. The method of claim 1, wherein determining the relevance between the message context and the recipient device contexts further comprises:
calculating a relevance score measuring the correlation of the message context to each recipient device context.

5. The method of claim 1, wherein determining the sending device context and wherein determining the recipient device contexts further comprise:
filtering context information received from at least one of a physical context module, computing context module, user context module, analytic context module, or data context module.

6. The method of claim 5 wherein respective physical context modules, respective computing context modules, respective user context modules, respective analytic context modules, and respective data context modules are local to the sending device and local to each of the plurality of recipient devices.

7. The method of claim 6, further comprising:
if the message context is irrelevant to the recipient devices of the first recipient group, predicting when the group message will become relevant to the recipient devices of the first recipient group with the analytic context module local to each of the recipient devices of the first recipient group, and;
notifying the sending device, with each of the recipient devices of the first recipient group, the prediction of when the group message will become relevant to the respective recipient devices of the first recipient group.

8. The method of claim 6 wherein the MCDM is local to the sending device.

9. The method of claim 6 wherein the MCDM is communicatively connected via a network with the sending device and the plurality of recipient devices.

10. A method of delivering a contextually relevant group message comprising:
receiving, with a message context and delivery manager (MCDM) from a sending device, a group message designated for delivery to a plurality of recipient devices;
determining, with the MCDM, a message context of the group message;
determining, with the MCDM, a sending device context of the sending device;
determining, with the MCDM, a recipient device context for each of the recipient devices;
determining, with the MCDM, relevance between the message context and the recipient device contexts, and;
delivering, with the MCDM, the group message to the plurality of recipient devices if the message context is relevant to the recipient device contexts.

11. The method of claim 10 further comprising:
determining the relevance between the message context, the recipient device contexts, and the sending device context.

12. The method of claim 10, wherein determining the relevance between the message context and the recipient device contexts further comprises:
calculating a relevance score measuring the similarity of the message context with the recipient device contexts.

13. The method of claim 10, wherein determining the relevance between the message context and the recipient device contexts further comprises:
calculating a relevance score measuring the correlation of the message context to the recipient device contexts.

14. The method of claim 10, wherein determining the sending device context and wherein determining the recipient device contexts further comprise:
filtering context information received from at least one of a physical context module, computing context module, user context module, analytic context module, or data context module.

15. The method of claim 14, wherein respective physical context modules, respective computing context modules, respective user context modules, respective analytic context modules, and respective data context modules are local to the sending device and local to each recipient device.

16. The method of claim 15, further comprising:
if the message context is irrelevant to the plurality of recipient devices, predicting when the group message will become relevant to the plurality of recipient devices with the analytic context module local to each recipient device, and;
notifying the sending device, by the recipient device, the prediction of when the group message will become relevant to the plurality of recipient devices.

17. The method of claim 14 wherein the MCDM is local to the sending device.

18. The method of claim 14 wherein the MCDM is communicatively connected via a network with the sending device and the plurality of recipient devices.

19. A system that delivers a contextually relevant group message comprising:
a message context and delivery manager (MCDM) that receives a group message designated for delivery to a plurality of recipient devices comprising a first recipient group and a second recipient group, the MCDM comprising:
a message context module that determines a message context of the group message;
a participant context aggregator that determines a sending device context of the sending device and determines a recipient device context for each of the plurality of recipient devices;
a context relevance calculator that determines the relevance between the message context and each of the recipient device contexts, and;
a message agent that delivers the group message to the first recipient group if the message context is relevant to the recipient device contexts of the recipient devices within the first recipient group and the quantity of recipient devices within the first recipient group exceeds a base percentage of the plurality of recipient devices.

20. The system of claim 19, wherein the MCDM is communicatively connected via a network with the sending device and the plurality of recipient devices.
